(19) United States
(12) Patent Application Publication
(10) Pub. No.: US 2010/0178411 A1
(43) Pub. Date: Jul. 15, 2010

(54) Agave-plant-based composition of matter and methods of use

(75) Inventor: Mark Mayer, Alma, CO (US)

Correspondence Address: Oppedahl Patent Law Firm LLC, P O Box 5940, Dillon, CO, 80435-5940, US

(73) Assignee: ALMA IMPORTS, INC., Aspen, CO (US)

(21) Appl. No.: 12/651,939

(22) Filed: Jan. 4, 2010

Related U.S. Application Data
(60) Provisional application No. 61/144,423, filed on Jan. 13, 2009.

(51) Int. Cl. C12G 3/06; C12G 3/07; C12G 3/04

(52) U.S. Cl. 426/592; 426/418

(57) ABSTRACT

An agave-plant-based composition of matter is disclosed that incorporates a nectar derived from the agave plant and mixed in small, discrete proportions with distilled spirits, where the distilled spirits are mostly comprised of the product of the fermentation and distillation of the juice from the core of one or more agave plants.

This application claims the benefit of U.S. patent application No. 61/144,423 filed Jan. 13, 2009, which is incorporated by reference for all purposes.

### BACKGROUND OF THE INVENTION

Tequila and tequila-like spirits (e.g., mescal) are often characterized by the bitterness of a cactus, with woody or smoky notes. The degree of these characteristics and the degree that these characteristics are considered less than pleasant to taste depends in large part to various factors associated with the making of the tequila or tequila-like spirit. These factors include the percentage of fermentable sugars used to make the spirit that originate from agave plants, the type(s) of agave plants used, the type(s) of yeasts used in the fermentation process, how long the spirit has aged and whether it was aged in oak wood containers, etc.

Much like Champagne and Cognac are indigenous to France, Tequila is identified by the geographic region from which it originates; that is, the Tequila region in Mexico. Tequila is made from the blue agave plant, which is a member of the lily family. Tequila-like spirits may incorporate the fermented sugars from other types of agave plants. The blue agave has spiny broad leaves called pencas. Early Indians used the agave spines as sewing needles, made paper from its leaves, and used the agave's juices for medicinal purposes.

It typically takes eight to 12 years for a blue agave plant to mature. Jimadors, the workers who harvest agaves, are experts in blue agave cultivation. The jimadors use tools such as a coa (a steel-tipped hoe) to unroot the blue agave plant from the unique lava red soil, and a machete to cut the spiny leaves from the body of the plant to reveal a large pineapple-shaped heart or core called a pina. The pinas, weighing as much as 150 pounds, are then shipped to a distillery to begin the tequila-making process. Most tequila producers contract with area farmers and buy agaves in the spot market. Agaves grown outside the distillery undergo a rigorous process that ensures the maturity, weight and quality of these in as meet the high standards of the distilleries. If rejected, the agaves may then returned to either the commissioned farmers or the spot market.

The pinas, which are comprised of pure starch, are steamed or baked in stone ovens for typically 24 to 36 hours at temperatures reaching 80 to 95 degree Celsius. A raw pina has a pale yellow color and is virtually odorless. In comparison, a cooked pina possesses a brown-orange color and emits a sweet, candy-like scent. Cooked pinas are then crushed in pressing mills in order to extract the agave juice. Agave fibers tend to reabsorb much of the juice, so the fibers are washed in order to obtain the optimal amount of juice/sugar from each press. The result of the wash is called aguamiel or honey water.

The aguamiel (honey water) is combined with select yeasts and placed in a vat to ferment, resulting in a variety of by-products that include ethanol and methanol. The fermentation process is dependent upon climate. A cooler climate can lengthen the processing time to up to 12 days whereas a warmer climate can shorten the time to two to five days. The product is later subjected to a double-distillation process to make tequila.

According to Mexican law, distilled tequila must be aged in oak barrels. The youngest blanco (white) tequilas, must be aged for 14 to 21 days; oro (gold) tequilas are aged up to two months; Reposado (rested) tequilas are aged up to one year; and the oldest tequilas, anejos (aged), are aged for at least one year. Unlike other spirits, the maximum benefits from the tequila aging process are largely realized after roughly six to 10 years.

While several species of the agave plant can be fermented and distilled to make alcoholic beverages, only the Agave azul tequilana weber, commonly called the Agave azul or blue agave, can be used to make “official” tequila. Due to a unique combination of altitude, soil conditions, humidity, annual rainfall, average temperature and exposure to the sun, southwest Mexico is the only known place in the world where Abave azul (or blue agave) grows naturally.

In an effort to preserve the integrity of the substance known as tequila, the Mexican government requires that “official” tequila meet the following criteria:

It must be made from 100 percent natural ingredients;

It must be produced with no less than 38 percent alcohol by volume (ABV);

It must be made from blue agave grown and harvested only in the Mexican states of Jalisco, Guanajuato, Michoacan, Nayarit or Tamaulipas;

The fermented agave juice must be distilled twice and the finished product must result from the agave juice processing;

The final product must be produced from no less than 51 percent reduced sugars from the blue agave; and

It must be labeled with ‘hecho en Mexico’ (made in Mexico), ‘NOM’ (Norma Official Mexicana), the producer's four digit registration and identification number, and the tequila's age (resposado, anejo, blanco, oro).

However, while many people enjoy the making of elaborate cocktails using tequila or tequila-like spirits as the base spirit in combination with multiple and widely varied ingredients, many people find the direct taste of tequila less than pleasing and often like a bitter, smoky cactus-like flavor. It is desirable to have a tequila or tequila-like base spirit that has a much better direct taste, which would not require the elaborate making of a cocktail to mask.

The use of agave syrup as a natural sweetener has been explored for various applications such as sweetener for chocolate or tequila. See, for example U.S. Patent Application Publication 2008/0299258 to Roman et al., U.S. Patent Application Publication 2008/0248183 to Brown, and U.S. Patent Application Publication 2008/0248176 to Brown.

### SUMMARY OF THE INVENTION

Where tequila spirits and tequila-like spirits leave off by making use of the cores of agave plants to ferment the sugars derived therefrom into alcohol and methanol, the present invention improves the direct taste of tequila by incorporating a nectar derived from the agave plant and mixed in small, discrete proportions with the produced tequila or tequila-like spirits. The agave nectar used is preferably from the blue agave plant and is added to tequila or tequila-like spirits at a concentration of ⅛ to ½ teaspoon of agave nectar per liquid ounce of tequila or tequila-like spirits. The mixture can take place before or after aging of the tequila. This composition of matter is optimized when blue agave nectar is mixed with pure tequila (that is, tequila whose fermented sugars originate from 100% blue agave plants) that has been aged for at least one year in oak containers.

### DETAILED DESCRIPTION

Where tequila spirits and tequila-like spirits leave off by making use of the cores of agave plants to ferment the sugars derived therefrom into alcohol and methanol, the present invention improves the direct taste of tequila by incorporating a nectar derived from the agave plant and mixed in small, discrete proportions with the produced tequila or tequila-like spirits. The agave nectar used is preferably from the blue agave plant and is added to tequila or tequila-like spirits at a concentration of ⅛ to ½ teaspoon of agave nectar per liquid ounce of tequila or tequila-like spirits. The mixture can take place before or after aging of the tequila. This composition of matter is optimized when blue agave nectar is mixed with pure tequila (that is, tequila whose fermented sugars originate from 100% blue agave plants) that has been aged for at least one year in oak containers.

The basic agave-plant-based composition of matter of the present invention comprises one or more liquid ounces of a distilled spirit, the majority by volume of which is comprised of the product of the fermentation and distillation of the juice from the core of one or more agave plants, and an additive comprising, ideally, ⅛-½ teaspoon of agave nectar per liquid ounce of said distilled spirit, said agave nectar being substantially mixed with said distilled spirit, whereby said mixture appears as sweetened to the taste. However, the amount of agave nectar per liquid ounce of said distilled spirit can be as high as one teaspoon. The effectiveness of the composition improves as the purity and/or aging of the distilled spirit improves. That is, as the percentage of the distilled spirit based on the product of the fermentation and distillation of the juice from the core of one or more agave plants increases, so does the quality and effectiveness of the resultant composition of matter. Likewise, as the distilled spirit's aging increases (before or after mixing with the agave nectar), the quality and effectiveness of the resultant composition of matter improves.

Further, the agave-plant-based composition of matter of the present invention can be formulated before or after storage in bottles and the like. It may be desired by some to introduce the hint of agave nectar just prior to serving the composition to a person for consumption. Additionally, the agave-plant-based composition of matter of the present invention may be used in conjunction with myriad additional ingredients for the making of traditional cocktails, where the use of the agave-plant-based composition of matter of the present invention reduces the bitter taste and reduces the need for additional sweeteners to make a drink palatable.

Of course, the agave-plant-based composition of matter of the present invention can lead to myriad end-user concoctions for consumption by humans. Sealed containers containing the agave-plant-based composition of matter of the present invention can be sold to, or otherwise delivered to, one or more end users. Said sealed containers are then opened, and the contents can be served “straight” to human users as a beverage for consumption. Alternatively, in one possible embodiment, the contents from said seal container can be mixed with juice from critrus fruit; for example, fresh-squeezed lime juice. Said mixtures are then consumed by human users.

### Potential Obvious Variations and Improvements

Those skilled in the art will have no difficulty devising myriad obvious variations and improvements to the invention, all of which are intended to be encompassed within the scope of the claims which follow.

1. A composition of matter comprising:
one or more liquid ounces of a distilled spirit, the majority by volume of which is comprised of the product of the fermentation and distillation of the juice from the core of one or more agave plants; and
an additive comprising ⅛-½ teaspoon of agave nectar per liquid ounce of said distilled spirit, said agave nectar being substantially mixed with said distilled spirit, whereby said mixture appears as sweetened to the taste.

2. The composition of matter of claim 1 wherein said product of the fermentation and distillation of the juice from the core of one or more agave plants comprises 51-60 percent of the volume of said distilled spirit.

3. The composition of matter of claim 1 wherein said product of the fermentation and distillation of the juice from the core of one or more agave plants comprises greater than 60 and up to 70 percent of the volume of said distilled spirit.

4. The composition of matter of claim 1 wherein said product of the fermentation and distillation of the juice from the core of one or more agave plants comprises greater than 70 and up to 80 percent of the volume of said distilled spirit.

5. The composition of matter of claim 1 wherein said product of the fermentation and distillation of the juice from the core of one or more agave plants comprises between 80 and 100 percent of the volume of said distilled spirit.

6. The composition of matter of claim 1 wherein said product of the fermentation and distillation of the juice from the core of one or more agave plants comprises 100 percent of the volume of said distilled spirit.

7. The composition of matter of claim 1 wherein said additive comprises ⅛-¼ teaspoon of agave nectar.

8. The composition of matter of claim 1 wherein said additive comprises ⅜-½ teaspoon of agave nectar.

9. The composition of matter of claim 1 wherein said additive comprises between ¼ and ⅜ teaspoon of agave nectar.

10. The composition of matter of claim 1 wherein said distilled spirit contains at least 38 percent alcohol by volume.

11. The composition of matter of claim 1 wherein said distilled spirit is aged in one or more containers comprised substantially of oak wood for 14-21 days prior to said mixing with said additive.

12. The composition of matter of claim 1 wherein said distilled spirit is aged in one or more containers comprised substantially of oak wood for 2 months prior to said mixing with said additive.

13. The composition of matter of claim 1 wherein said distilled spirit is aged in one or more containers comprised substantially of oak wood for between 2 months and one year prior to said mixing with said additive.

14. The composition of matter of claim 1 wherein said distilled spirit is aged in one or more containers comprised substantially of oak wood for at least one year prior to said mixing with said additive.

15. The composition of matter of claim 1 wherein said additive is introduced to said distilled spirit prior to bottling said mixture for storage.

16. The composition of matter of claim 1 wherein said additive is introduced to said distilled spirit just prior to serving for ingestion by a human being.

17. A method of making a composition of matter comprising the steps of:
obtaining one or more liquid ounces of a distilled spirit, the majority by volume of which is comprised of the product of the fermentation and distillation of the juice from the core of one or more agave plants;
adding an additive comprising ⅛-½ teaspoon of agave nectar per liquid ounce of said distilled spirit to said distilled spirit; and
substantially mixing said agave nectar with said distilled spirit, thereby causing said mixture to appear as sweetened to the taste.

18. The method of claim 17 wherein said product of the fermentation and distillation of the juice from the core of one or more agave plants comprises 51-60 percent of the volume of said distilled spirit.

19. The method of claim 17 wherein said product of the fermentation and distillation of the juice from the core of one or more agave plants comprises greater than 60 and up to 70 percent of the volume of said distilled spirit.

20. The method of claim 17 wherein said product of the fermentation and distillation of the juice from the core of one or more agave plants comprises greater than 70 and up to 80 percent of the volume of said distilled spirit.

21. The method of claim 17 wherein said product of the fermentation and distillation of the juice from the core of one or more agave plants comprises between 80 and 100 percent of the volume of said distilled spirit.

22. The method of claim 17 wherein said product of the fermentation and distillation of the juice from the core of one or more agave plants comprises 100 percent of the volume of said distilled spirit.

23. The method of claim 17 wherein said additive comprises ⅛-¼ teaspoon of agave nectar.

24. The method of claim 17 wherein said additive comprises ⅜-½ teaspoon of agave nectar.

25. The method of claim 17 wherein said additive comprises between ¼ and ⅜ teaspoon of agave nectar.

26. The method of claim 17 wherein said distilled spirit contains at least 38 percent alcohol by volume.

27. The method of claim 17 wherein said distilled spirit is aged in one or more containers comprised substantially of oak wood for 14-21 days prior to said mixing with said additive.

28. The method of claim 17 wherein said distilled spirit is aged in one or more containers comprised substantially of oak wood for 2 months prior to said mixing with said additive.

29. The method of claim 17 wherein said distilled spirit is aged in one or more containers comprised substantially of oak wood for between 2 months and one year prior to said mixing with said additive.

30. The method of claim 17 wherein said distilled spirit is aged in one or more containers comprised substantially of oak wood for at least one year prior to said mixing with said additive.

31. The method of claim 17 wherein said additive is introduced to said distilled spirit prior to bottling said mixture for storage.

32. The method of claim 17 wherein said additive is introduced to said distilled spirit just prior to serving for ingestion by a human being.

33. A method for using an agave-plant-based composition of matter; said agave-plant-based composition of matter comprised of one or more liquid ounces of a distilled spirit, the majority by volume of which is comprised of the product of the fermentation and distillation of the juice from the core of one or more agave plants, and an additive comprising ⅛-½ teaspoon of agave nectar per liquid ounce of said distilled spirit, said agave nectar being substantially mixed with said distilled spirit, whereby said mixture appears as sweetened to the taste; said method comprising the steps of:
obtaining a beverage-drinking container;
opening a container of said agave-plant-based composition of matter;
filling said beverage-drinking container 20-80% full with said agave-plant-based composition of matter;
into said beverage-drinking container, mixing in juice originating from a citrus fruit selected from the group consisting of lime, lemon, orange, grapefruit, clementine, tangerine, pomelo, papeda, and kumquat;
providing said beverage-drinking container to a human being, whereby said human being is enabled to substantially ingest the contents of said beverage-drinking container.

34. The method of claim 33 wherein said product of the fermentation and distillation of the juice from the core of one or more agave plants comprises 51-60 percent of the volume of said distilled spirit.

35. The method of claim 33 wherein said product of the fermentation and distillation of the juice from the core of one or more agave plants comprises greater than 60 and up to 70 percent of the volume of said distilled spirit.

36. The method of claim 33 wherein said product of the fermentation and distillation of the juice from the core of one or more agave plants comprises greater than 70 and up to 80 percent of the volume of said distilled spirit.

37. The method of claim 33 wherein said product of the fermentation and distillation of the juice from the core of one or more agave plants comprises between 80 and 100 percent of the volume of said distilled spirit.

38. The method of claim 33 wherein said product of the fermentation and distillation of the juice from the core of one or more agave plants comprises 100 percent of the volume of said distilled spirit.

39. The method of claim 33 wherein said additive comprises ⅛-¼ teaspoon of agave nectar.

40. The method of claim 33 wherein said additive comprises ⅜-½ teaspoon of agave nectar.

41. The method of claim 33 wherein said additive comprises between ¼ and ⅜ teaspoon of agave nectar.

42. The method of claim 33 wherein said distilled spirit contains at least 38 percent alcohol by volume.

43. The method of claim 33 wherein said distilled spirit is aged in one or more containers comprised substantially of oak wood for 14-21 days prior to said mixing with said additive.

44. The method of claim 33 wherein said distilled spirit is aged in one or more containers comprised substantially of oak wood for 2 months prior to said mixing with said additive.

45. The method of claim 33 wherein said distilled spirit is aged in one or more containers comprised substantially of oak wood for between 2 months and one year prior to said mixing with said additive.

46. The method of claim 33 wherein said distilled spirit is aged in one or more containers comprised substantially of oak wood for at least one year prior to said mixing with said additive.

47. The method of claim 33 wherein said agave-nectar additive is introduced to said distilled spirit prior to bottling said mixture for storage.

48. The method of claim 33 wherein said agave-nectar additive is introduced to said distilled spirit just prior to serving for ingestion by a human being.
